(19) United States
(12) Patent Application Publication
(10) Pub. No.: US 2006/0207170 A1
(43) Pub. Date: Sep. 21, 2006

(54) Hair felt

(76) Inventor: Gerald Murray Smith, Auckland (NZ)

Correspondence Address: YOUNG & THOMPSON, 745 SOUTH 23RD STREET, 2ND FLOOR, ARLINGTON, VA, 22202, US

(21) Appl. No.: 10/564,280

(22) PCT Filed: Jul. 13, 2004
(86) PCT No.: PCT/NZ04/00149

§ 371 Date: May 1, 2006

(30) Foreign Application Priority Data
Jul. 15, 2003 (NZ) 527017

(51) Int. Cl. A01C 1/04

(52) U.S. Cl. 47/56

(57) ABSTRACT

A natural biodegradable felt suitable for growing seeds, seedlings or plants comprises a needlepunched felt mat formed of unscoured greasy wool, with or without additional nitrogenous material in the form of crushed or rolled animal excreta (dags). One such mat has a base which is sufficiently dense that it suppresses the growth of weeds through the mat, while being sufficiently loose in the upper surface to enable scattered seeds to be impregnated into the mat, and to grow through the mat when watered. The mat and seeds can be shrink wrapped and rolled to provide an instant lawn. An alternative version uses a different density substrate for use in hydroponics, or for the delivery of growing plants such as lettuce or herbs to supermarkets.

### TECHNICAL FIELD OF THE INVENTION

The present invention relates to substrates suitable for growing seeds, seedlings, or plants and methods of manufacture thereof.

In this specification the substrate is sometimes referred to as a “plant liner”. Throughout this specification, the term “plant liner” has been used in broad sense as a product that can be used in a growing medium, about or over a growing medium or as a growing medium for plants. Accordingly, the meaning of the term “plant liner” is not intended to be limited solely to a material that is to be placed inside an article.

### BACKGROUND OF THE INVENTION

Various types of plant substrates or plant liners have been proposed, each having their own characteristics and uses. Some have been used to anchor plants in hydroponics, some for growing seedlings, and some for keeping plants alive during transport. The plant liners may be inserted into pots, placed under pots or themselves be formed into a plant pot.

Plant liners of the prior art have been made from a variety of materials, including rock and mineral wool and some plant fibres such as coconut fibres and sphagnum moss. Rock and mineral wool are synthetic products and as such are not particularly environmentally sound. They are not biodegradable. Plant fibre plant liners may be difficult and/or messy to handle and may have limited applications.

### OBJECT OF THE INVENTION

It is an object of the present invention to provide a natural felt that can be used as a substrate or plant liner and/or to provide a method of manufacturing a natural felt that can be used as a substrate or plant liner that has improved characteristics, or at least to provide the public with a useful choice.

### SUMMARY OF THE INVENTION

In one aspect the invention provides a natural felt comprising a mass of predominately unscoured animal wool, hair or fur formed into a felt.

In another aspect the invention provides a method of manufacturing a natural felt suitable for growing seeds, seedlings or plants, the method including producing a batt formed at least in part from unscoured animal wool, needlepunching the batt to form a felt, and forming the felt into a required shape or length.

The invention will be more fully understood by reading the claims, the contents of which are incorporated herein by way of reference.

The inventive step is the use of unscoured animal wool or hair or fur, with or without the presence of faeces (and in particular for the use of dag wool) to produce a number of different felts suitable for growing plants in the soil, in hydroponic applications, and for use as mulching pads on the surface of soil, as well as weed suppressant mats, and in some cases as thermal insulation for plants such as vines in vineyards. By using predominately unscoured animal wool, and in particular sheep wool having a percentage of dag wool present, by being able to use a considerable proportion of very short fibre wool which is not usable in textile processes, it is possible to produce a natural, biodegradable, and effective product for a variety of horticultural and biological purposes.

“Felt” is used herein to refer to any “non-woven” mass of interlocked fibres.

The various aspects of the invention will be become apparent from the following description, which is given by way of example only, with reference to the accompanying drawings.

### BRIEF DESCRIPTION OF THE DRAWINGS

FIG. 1 shows a flow chart of the steps taken to produce a plant liner in accordance with the present invention.

FIG. 2 shows a possible product made from the plant liner of the present invention.

FIG. 3 shows another possible product made from the plant liner of the present invention.

FIG. 4 shows a two layer planting mat.

FIG. 5 shows a shrink wrapped “instant lawn”.

FIG. 6 shows a planting cube.

FIG. 7 shows a planting cube in cross section.

FIG. 8 shows a hydroponic channel

FIG. 9 shows a planting disk at the bottom of a pot.

FIG. 10 shows a planting disk at the top of a pot.

FIG. 11 shows a liner for a hanging basket.

FIG. 12 shows a liner biodegradable peg in perspective.

FIG. 13 shows the biodegradable peg in front elevation.

FIG. 14 shows pre-seeded mats pegged to sand dunes.

FIG. 15 shows a hanging basket formed almost entirely from natural felt.

FIG. 16 shows a biodegradable plant pot made from natural felt.

### DETAILED DESCRIPTION OF THE EXAMPLES

The present invention relates to natural felts especially for use as substrates and plant liners and methods of producing natural felts. By “natural felts” we refer to felts made predominately of unscoured greasy animal wool (especially sheep wool). The substrates and plant liners of the present invention are constructed from unscoured wool, which has been found by the Applicant to provide a surprisingly good growing medium for plants.

Plant liners are intended to provide improved growing conditions for plants, often by retaining moisture in the location of the roots of the plants. Various plant liners and plant pots have been proposed to retain water about the plant roots.

Wool is hydrophilic, which is one of its properties that make it suitable for use as a plant liner. In addition, the Applicant has identified that unscoured wool contains nutrients that promote plant growth. Unscoured sheep wool typically contains Nitrogen, Sulphur, Potassium and Magnesium, making unscoured sheep wool particularly advantageous for use as a plant liner. In addition, and perhaps surprisingly, unscoured wool does not appear to promote bacterial and fungal growth after being moistened. It also provides a suitable substrate for additional nutrients and plant growth promoters which can be added to the wool during processing.

### EXAMPLE 1

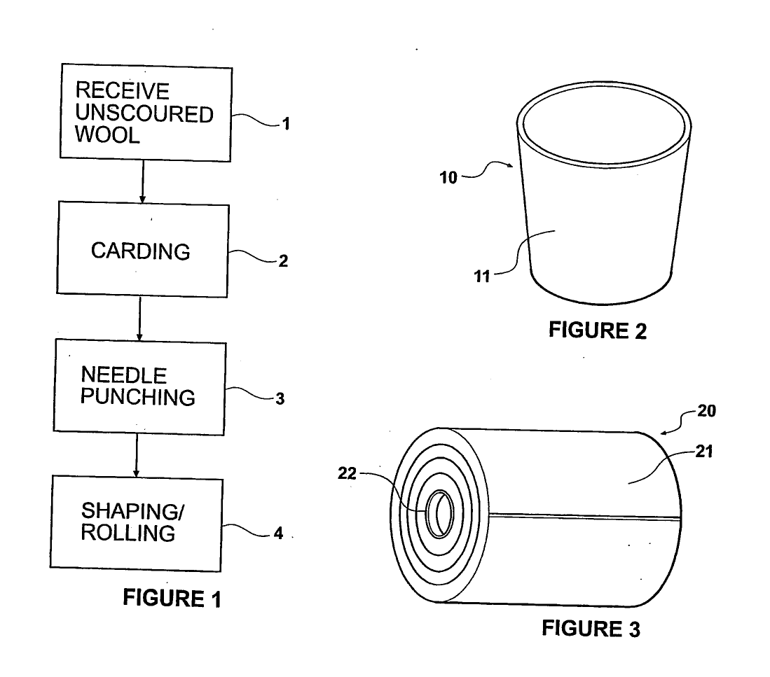

Referring to FIG. 1 a flow diagram of the steps to produce a natural felt according to the present invention is shown. The first step, step 1 involves receiving a quantity of unscoured wool. Unscoured wool is readily available for purchase. In a preferred form of the invention as presently contemplated, the unscoured wool includes at least a portion of dag wool. Dag wool includes a portion of animal faeces and may also include dirt and other contaminants.

Waste wool can be used. Unscoured waste wool from crutching and other operations typically contains short and previously unusable fibres of less than say 10 mm in length. If predominantly waste wool is used, it is preferable that at least 15% of the unscoured wool comprises longer fibres of more than 20 mm length to help bind the felt together.

The next step, step 2 is carding, a well known process to lay the wool fibres parallel to each other, forming a batt (web) of loosely associated fibres. A plurality of webs are superimposed on each other to obtain a required density and thickness, which may be between 4 - 20 cm for most applications. Those skilled in the relevant art will appreciate that methods other than carding may be used to form a batt, for example air laying or garneting.

Step 3 involves needlepunching the batt produced in step 2 to form a felt.

Needlepunching involves inserting many barbed needles through the batt to change create a non-woven fabric. Needlepunching changes the orientation of the fibres in the batt from generally horizontal to generally vertical: at the same time causing the fibres to interlock. Felting needle looms and needles suitable for needlepunching wool are well known and therefore will not be described further herein.

The resulting felt will be about 10 to 20 mm thick depending upon resultant density and its intended end-use. For most applications the felt will be about 10 mm thick, and have a weight of 600 g.s.m. (grams per square metre), and an average density of about 0.06 g/c.c. (grams per cubic centimeter).

Step 4 involves shaping the felt or rolling the felt onto a roll. It is anticipated that the felt will be produced in lengths, which are rolled directly onto a spindle 22 to form a roll 20 (see FIG. 3). Required sub-lengths of felt from the main length 21 may then be removed from the roll 20 and cut into a required shape for use. For example, the felt may be cut into a shape so that it could be formed into an annular insert 10 (see FIG. 2) for a pot.

The length 21 of felt formed into the roll 20 may be particularly useful as a geotextile, allowing relatively easy placement of large areas of felt, for example, by locating the roll on the back of a trailer or light truck. The roll 20 may be a convenient way to transport the length 21 to another location where retail products, such as the insert 10 may be produced.

If a “loose” felt (i.e. a low density felt having openings to receive seeds) is produced, seeds may be shaken into the felt. The seeds may be shaken into the felt prior to forming a roll 20. The felt may then act as both a store of water to encourage growth and as a weed mat or mulch mat, discouraging growth of competing plants. A binding solution may be applied to the liner to assist in the retention of seeds in the felt. As an alternative to shaking seeds into the felt, the seeds may be inserted using a mechanical drill or may be applied during the needle punching process using specialised needles and looms. The wool felt may help to regulate the temperature of the seeds and/or the roots of established plants.

### EXAMPLE 2

A planting mat is prepared from a 20 mm thick felt of greasy unscoured sheep's wool having the following composition:
80% w/w of short fibres <20 mm in length (most of which are below 10 mm in length).
5% w/w dags
15% w/w of longer fibres >20 mm in length.

The dags and any fibres containing dags are first dried then crushed between pressure rollers and mixed with the remaining fibres, to provide a fairly even distribution of the crushed dags in the final product.

The mixture is then carded and needlepunched as in Example 1 to create a felt of unscoured greasy wool. Preferably the fibres are kept dry (minimal water content) during processing. The felt is produced in suitable widths. For most applications a width of 1.2 metres is practical.

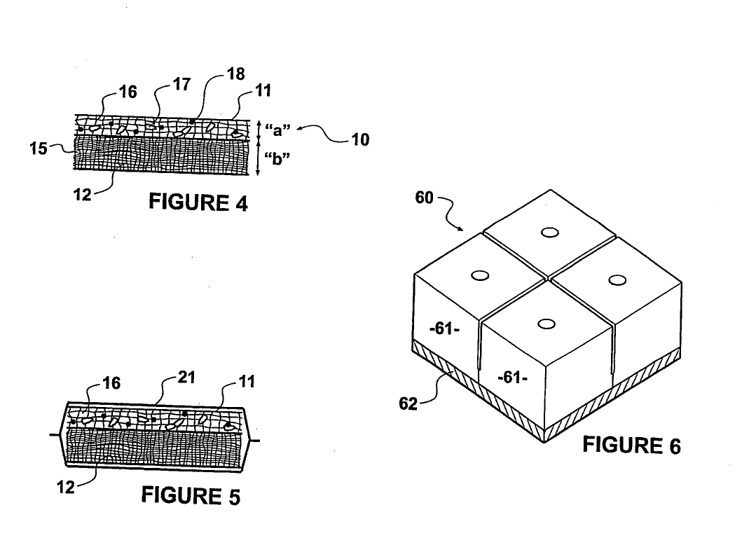

This planting mat 10 is formed with two visibly distinct layers as shown in FIG. 4 though they are part of the same mass of needlepunched wool. An upper layer 11 is a relatively “loose” or “open” felt of a lower density than the lower layer 12. The lower layer 12 has an average density of about 0.1 g/lc.c, and has an average thickness “b” of 15 mm. The upper layer has a density of about 0.05g/c.c. and an average thickness “a” of 5 mm. The average mass of such a mat is between 500 g.s.m. and 600 g.s.m. (This is the “dry” weight of the unscoured wool at 20°C).

The different densities of the mat 10 can be controlled by the quantity of fibres and the extent of needlepunching. The longer the mat is needlepunched the denser the mat as the fibres become more and more interlocked.

Preferably the mat is needlepunched from both sides (from above and below) as the mass of fibres forming the batt are moved through the needlepunching machine.

By making the upper layer 11 a lower density than the lower layer 12, it allows layer 11 to be open and loose enough for seeds 18 to be interposed between the fibres 16 of the upper layer. Also the crushed dags 17 are visible in this upper layer. In practice they will be distributed throughout both layers, though less visible in the denser more opaque lower layer 12.

The lower layer 12 is both thicker and denser than the upper layer as it is more needlepunched to create a dense opaque mat of the unscoured wool fibres (15). By making at least this lower layer sufficiently dense and opaque to sunlight the mat can function as a weed suppressant mat. In use seeds in the upper layer will germinate and their roots will grow down through both layers into the soil below. But weeds will find it difficult to grow up through the two layers. The mat density will also assist in controlling the root micron size.

### EXAMPLE 3

“Instant lawn” mats 20 (see FIG. 5) can be created by producing rolls of the planting mat as in example 2, with a lower density upper layer 11, and a denser lower layer 12. The upper layer is provided with a uniform distribution of grass seeds which are trapped between the fibres 16. At this stage the mat is dry, and can be covered with a suitable waterproof plastics film. A thin polyethylene film 21 can be applied top and bottom and sealed around its edges, effectively “shrink wrapped” about the mat to keep the wool and seeds dry until needed. The shrink wrapped mats can then be rolled and stored ready for use.

Typical rolls when unrolled will be 1.2 metres wide, 20 mm thick and 20 metres long. They are about 10 mm thick and have an average mass of 600 g.s.m. (grams per square metre).

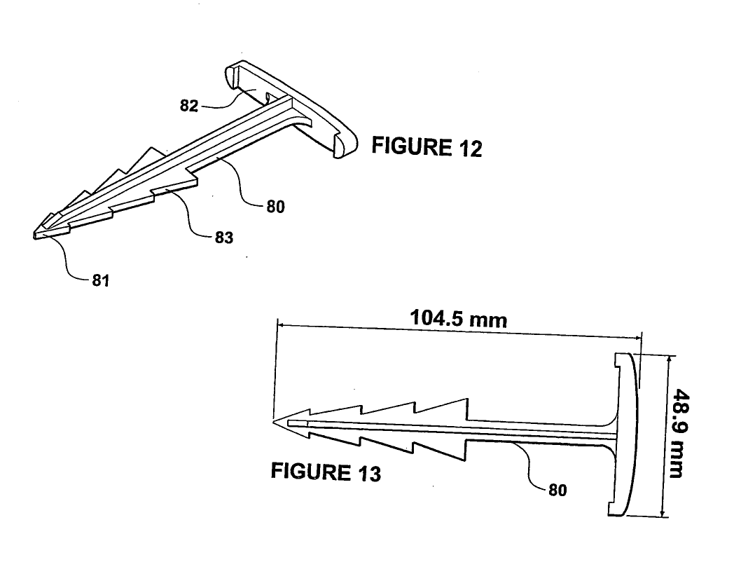

In use an instant lawn can be created by unrolling the pre-seeded mats, removing the covering of plastics film, and pegging the mats to the ground with biodegradable pegs or staples. The mats can then be lightly watered. The wool will take up about 40% of its weight in water. Suitable biodegradable pegs are shown in FIGS. 12 and 13. Alternatively, or in addition to the pegs, the mats can be weighed down with sand to hold them in place.

Tests of these mats show a rapid and strong and more uniform growth of lawn compared to seeds applied directly to the ground. The mats biodegrade as the grass grows and very little wool is visible in the ground after 3 months.

### EXAMPLE 4

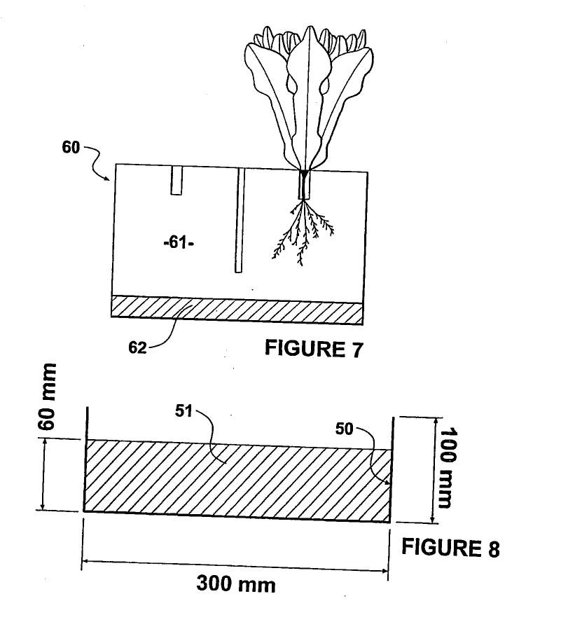

Seedling containers—These containers 60 are formed as a series of substantially cubical blocks 61 of felted unscoured wool. By needlepunching them to a density of about 0.07g/c.c with a slightly denser base layer 62 of 0.12 g/c.c then slitting the mats into partly joined cubes and punching a small cylindrical aperture in the top of each cube, a series of seedling container can be produced as shown in FIGS. 6 and 7. The cylindrical aperture need only be large enough to receive a seed or seedling.

They are suitable for pre-growing herbs, seedlings, lettuces etc so that they can be displayed at nurseries, sold as individual cubes or sets of cubes, taken home and then separated and the cubes planted in the garden.

A suitable size for each cube is 40×40×40 mm. The denser base 62 (if required) may be about 5 mm thick.

### EXAMPLE 5

Hydroponic substrate—This product 51 is designed to fit into hydroponic channels 50—see FIG. 8. For a channel (50) 300 mm wide and 100 mm high, a mass of unscoured wool 51 can be needlepunched to size (300 mm wide×60 mm thick).

The hydroponic substrate can be made as a uniform needlepunched mat 60 mm thick and cut to the desired width. Such a uniform mat preferably has an average density of about 0.085 g/c.c.

The density and thickness of the hydroponic substrate can be varied to provide the required porosity and desired “anchoring density” to allow for root growth and stability for the plant. Too dense a substrate will impede both porosity (and water flow through the substrate which substantially fills the channel) and also impede root growth. Too loose (lower density) substrate will be too porous (risk drying out) and be too loose to provide an anchoring support for the plants to be grown therein.

Trials with the hydroponic substrate of this example show that the nutrient rich unscoured greasy wool (without dags) allows for repeated cropping of leaf vegetables and herbs grown therein. We have tested both dag wool and unscoured wool without dags and found that for hydroponics that better and more uniform control of growth is achieved without dags.

### EXAMPLE 6

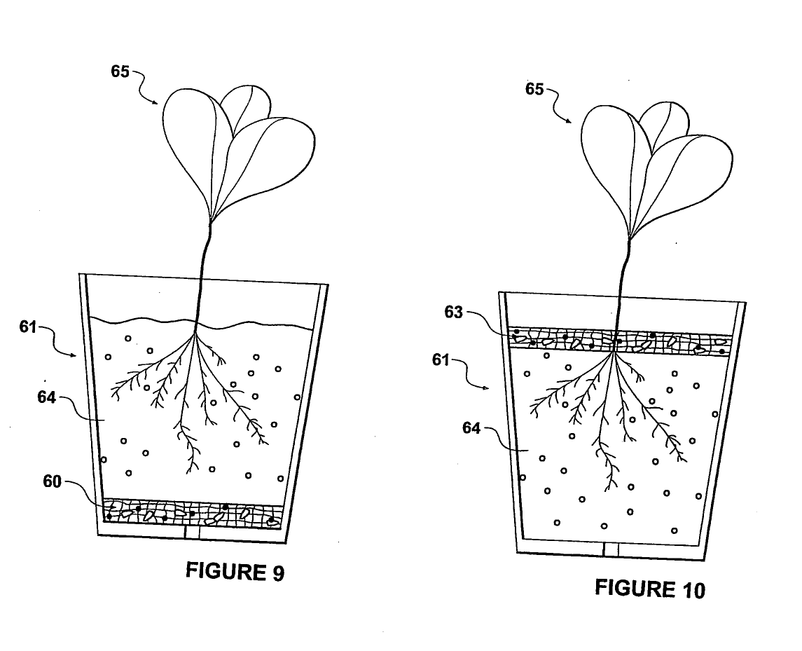

Pot plant liners—These can be formed of a uniform density felt of unscoured wool of 20 mm to 30 mm thick. Recommended density is about 0.04 to about 0.07 g/c.c. In FIG. 9 the disk 60 is 20 mm thick and placed at the base of a pot 61 and covered with soil.

In FIG. 9 to 11 we prefer to use unscoured wool with dags where the plants or seedlings will benefit from the nitrogen in the dags.

In FIG. 10, the unscoured wool felt disk 63 is 30 mm thick and placed on top of the soil 64 with the seed or seedlings 65 placed in a small incision in the felt disk.

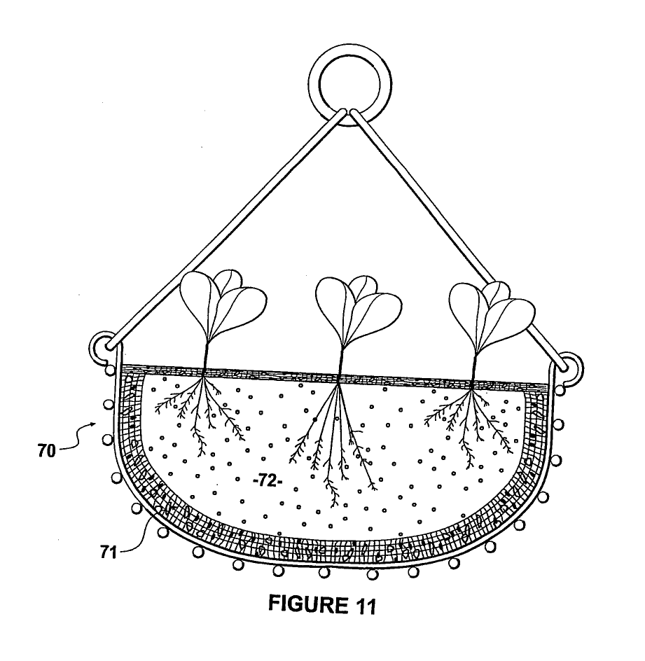

FIG. 11 shows a wire hanging basket 70 lined with a 30 mm thick piece of unscoured wool felt 71 and covered with soil 72. For basket liners the unscoured wool would be dyed with a natural dye to obscure its natural yellow colour.

Various liner shapes or pieces may be used in pots and baskets. The inclusion of portions of unscoured wool felt in pots, baskets or planters provides both nutrients for plant growth but also aids in the retention of water within the plant container. Wool is hydrophilic and self wicking and is able to draw moisture out of the air and into the pot. It assists in trapping dew within the pot.

### EXAMPLE 7

FIGS. 12 and 13 show a biodegradable peg. This peg has a pointed tip 81 and a T-shaped cross piece 82.

Preferably it has a series of barbs 83 towards the tip.

A peg suitable for pegging an instant lawn mat onto the ground, is about 100 mm long, and has a cross piece of about 15 mm wide. The specific example shown in FIG. 13 has an overall length of 104.5 mm and an overall width at the head of 48.9 mm.

If planting mats are to be used on sand dunes and banks or hillsides, where the underlying structure is somewhat loose, for example sand dunes, or loose friable soil, then somewhat longer pegs are desirable. We have tested pegs up to 200 mm long for this purpose.

The pegs are formed with a biodegradable material. Initial prototypes were formed starch, but we have found that the pegs can be injection moulded by using a biodegradable polymer. The most appropriate polymer to use is a polylactide polymer which is a polymer made primarily from a repeating chain of lactic acid. It is designed to be broken down by microbes in the soil.

One such polymer is known as “pla polymer 3001 d” available from Nature Works (trade name).

### EXAMPLE 8

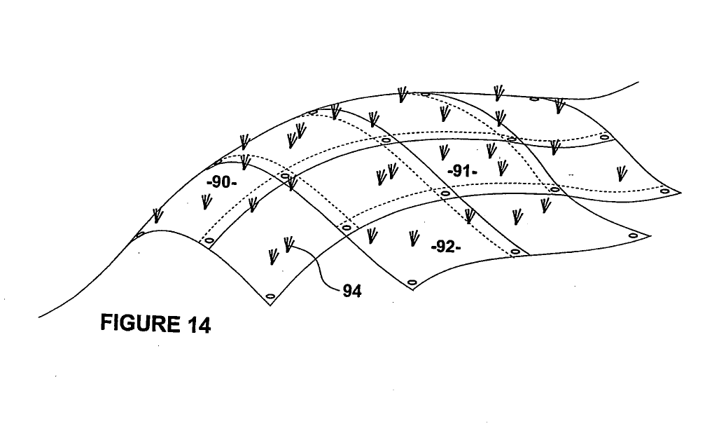

Sand Dunes—FIG. 14 shows a series of planting mats pegged to a sand dune using pegs 80 of the type shown in FIGS. 12 and 13, with the mats being overlapped slightly with one another to economise on the number of pegs, so that for example mat 90 overlaps the top edge of mat 91, and mat 91 overlaps the top edge of mat 92. Such mats can be formed in a similar fashion to the mats described in examples 1 and example 2, and seeded with maram grass 94.

Since in this case the function of the planting mats is to encourage the growth of vegetation on the sand dunes, it is preferred that the mats are less dense than the mats used for instant lawns, and for economy, the mats can be loose, and transparent or translucent, with a density of about 0.02g/c.c. Loose dag wool is preferred, about 5 mm thick.

### EXAMPLE 9

Weed suppression mats—Mats having a density of about 0.1g/c.c. (and higher) are useful in suppressing weeds. By having the needlepunch to a density that they are effectively opaque to sunlight, they can be cut and shaped and pegged on the ground around mature trees or other plants, to prevent weeds from growing up through the soil and through the mat. They have the added advantage that they are biodegradable, and will provide nutrients to the soil. If left untreated the mats will break down over a period of 2-4 months, and it is believed that the fibres will be taken into the soil by worms and other insects. The denser the mat, i.e. the greater the degree of needlepunching, the greater the duration of its weed suppression property, as it takes longer for it to break down. In some cases these mats could be dyed with a natural dye, so that they blend into the soil, but this would depend upon user preference. The ability to suppress weeds is also dependent on the mat thickness. For most practical applications a thickness of about 10 mm is suitable.

### EXAMPLE 10

Frost protection—In most of the previous examples the unscoured animal wool, preferably sheep's wool, is used to provide nutrients, and to trap moisture, as wool will hold up to 40% by weight of water. However in some cases, the provision of a biodegradable natural mat can also make use of wool's ability to trap air. The natural felt of this invention can be used as a frost protection blanket for vines, and other frost sensitive plants. When not required for this frost protection purpose, it can be laid on the soil, and allowed to biodegrade and provide nutrients to the vines or other plants.

### EXAMPLE 11

Transport of shellfish—A natural felt of this invention made of sheep's wool, and preferably free from dags, similar in size and thickness to the mats of Example 1, can be used as packing material for the transport of shellfish, live fish, and crustaceans. By taking a large piece of the felt of about 12 mm thickness, having a density of about 0.07g/c.c. dipping it into seawater, to absorb seawater, squeezing it out to remove any excess water, and then using this as the lining of a box or bucket to be used for transporting shellfish, the shellfish can be placed inside the felt, with the felt wrapped over them. The felt blanket provides a reservoir of both seawater, and nutrients for the shellfish. It also provides a degree of thermal insulation, keeping the shellfish at a more even temperature.

A test of mussels wrapped in a seawater impregnated natural felt blanket, shows that the mussels remain in good health, and feed on the nutrients in the wool.

### EXAMPLE 12

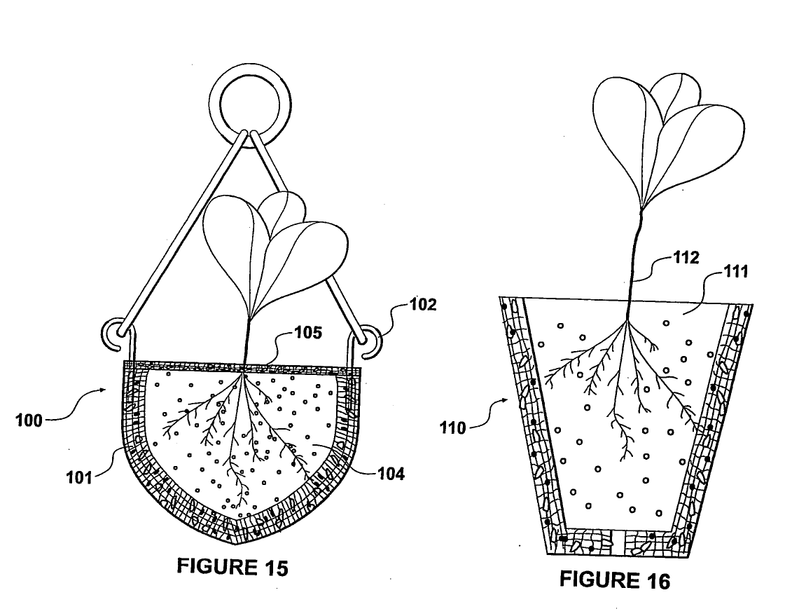

FIG. 15 shows a modified hanging basket 100 in which the exterior is formed from a dense natural felt 101 which has been moulded into shape. Suitable hooks 102 can be embedded in the felt walls, and the interior filled with a suitable potting mix 104. This natural felt 101 and the thin felt top cover 105 may be dyed a dark green or brown or black to hide the natural yellowish colour of the unscoured sheep wool. The felt is preferably intensively needlepunched from a corded belt of about 1000 to 1200 g.s.m. weight. The longer the needlepunching operation, the denser and stiffer the felt.

### EXAMPLE 13

FIG. 16 shows a biodegradable plant pot 110 pressed out of a relatively loose natural felt. It can be filled with potting mix 111 and a seedling 112. Suitable use—home gardener, or nurseries where seedling can be grown for sale in individual biodegradable pots. By making the pots out of a less dense felt than FIG. 15, the pots can be designed to be planted directly in the garden and controlled so that they provide the initial nutrients for the seedling but biodegrade within 4 to 6 weeks when inserted into the ground. They provide a better growing medium and stronger seedlings than those grown together In plastic punnets.

TABLE 1

| Density (Dry) | | Appearance | Uses |
|---|---|---|---|
| 0.02 to 0.04 | g/c.c. | Loose, easy to | Upper layer of planting |
| | | inserts seeds, | maters, especially |
| | | seedlings and | for “:instant lawn”. |
| | | other solids. | This mats for sand |
| | | | dunes. |
| 0.04 to 0.07 | g/c.c. | Fluffy, easy | Plant liner, pots disks, |
| | | to cut. | transport of shellfish. |
| 0.08 to 0.09 | g/c.c. | Medium density, | Plant liner, pot disks exterior |
| | | reasonable | of hydroponic substrate |
| | | porosity | |
| 0.09 to 0.1 | g/c.c. | Dense and opaque | Lower layer of seed planting |
| | | to sunlight | mat, especially for substrate |
| | | in thickness | lowers |
| | | greater than | |
| | | 10 mm | |
| 0.1 to 0.3 | g/c.c. | Very dense, but | Biodegradable weed |
| | | can be cut. | suppressant mat, insulation |
| | | | mat for grape vines. Can be |
| | | | moulded into plant pots. |
| >0.3 | g/c.c. | Very dense. | Could be used as moisture |
| | | Difficult to cut. | reservoir (not economic). |

Trials

These trials were conducted by an independent plant scientist on a felted mat of unscoured wool as per Example 1, derived from dag wool and associated faecal material. It is a fabric approximately 1cm thick. It had an average density of about 0.07 g/c.c. and was a relatively loose felt on top and a firmer / denser felt on the underside. In the tests below the “upper surface” is identified as the less dense felt surface.

Test undertaken.

Trial 1—Ability to Support Plant Growth

The product was cut into squares and placed in standard 2 litre square plastics ice cream containers. Similar squares of blotting paper were placed into similar containers, seven layers thick. This represented about a half the thickness of the wool product. Water was added to cover both wool and blotting paper.

Day Zero—Cress seed, wheat seed and sweet pea seed, were sown onto each of the substrates.

Initially germination of cress seed on the wool product was more even than on blotting paper as the extra thickness provided a more reliable supply of moisture. Subsequently growth was comparable on the two substrates. Initially roots were seen to penetrate the wool product, but not the blotting paper. On day 28 after the blotting paper had started to disintegrate roots were seen to have penetrated.

Germination of wheat seed on the wool product was earlier and stronger than that on the blotting paper. Subsequently the plants on the wool have grown larger and are a darker green than those on blotting paper. Both batches continue to grow well as of day 28. Roots penetrated the wool product from the outset, but by day 28 had still failed to penetrate the blotting paper.

The sweet pea seed was non viable and soon became covered in saprophytic fungal and bacterial growth. It was noted that blotting paper supported similar colonies of these organisms on its surface, whereas the wool product was not observed to do so.

Conclusion—The wool product is a good medium to support plant growth and appears to have factors which prevent or restrict observable fungal and bacterial growth.

Trial 2—Comparative Ability to Support Fungal, Algal and Bacterial Growth.

Following initial observations, a test was set up to compare the ability of (a) the wool product, (b) a cotton substrate and blotting paper to support microbial organisms.

Squares of the three substrates were cut as previously and placed in ice cream containers in a plant propagation tent on day zero. A duplicate set of the wool product was set up as the product has a recognizable upper and lower surface. One set had the upper surface uppermost while the other had the lower surface upper most. Cotton squares were obtained from a well washed cotton singlet.

By day 30 the wool product supported algal growth, equally on both upper and lower surface samples, but fungal and bacterial growth were not observable with the naked eye. The cotton substrate showed growth of fungal colonies.

The blotting paper also showed fungal growth, although this was less than in the test with non viable sweet pea seed which provided an inoculum source.

Conclusion—The wool product appears to have factors which prevent or restrict observable fungal and bacterial growth.

Trial 3—Use as a Mulch Mat

Plastic and cardboard sheeting are employed in horticulture as weed suppressant mulches, both domestically and commercially. Plastic sheeting presents environmental problems after use.

Lengths of the unscoured wool product were placed between rows of daffodils as felt matting. Alternate lengths were placed with the upper (looser) surface of the product up and vice versa on day zero. By day 44 the mulch had started to turn green as it supported algal growth. No weed had penetrated the felt matting from below despite the presence of perennial weeds such as dock.

The matting was walked upon during the period of the test in order to harvest blooms. There is no evidence of any mechanical degradation.

Trial 4—Hanging Basket Liner

The wool product was compared with traditional sphagnum and a preformed coir liner in hanging baskets. The liners were filled with standard UC potting mix and planted with pansies on day zero. The wool and coir products were easy to use, the sphagnum was more difficult and messy. The coir was considered to be aesthetically harsh. The sphagnum was initially the most pleasing. The colour of the wool product was considered inappropriate but could easily be dyed. The presentation of the product needs refinement.

By day 20 growth of the pansies was comparable and in as much as it was mid winter and water demands low there was no perceivable difference in “need to water”. This could well be different in summer and with suspended baskets.

Trial 5—Properties of the Product

The smell of the dry product made from unscoured dag wool is very “rich” and may need to be hermetically sealed for retail use, although the product made from unscoured wool free from dags is less noticeable.

On day zero five squares of the dag wool product 20 cm×20 cm were placed in a 4 lt ice cream container and covered with water. Initially when wetted the smell ameliorated, but after six weeks when disturbed a distinct, probably anaerobic odour was evident.

A pH measurement was made on the liquor on day 44. A reading of 7.2 was recorded. This is near optimum for the growth of most plants. With a higher concentration of dags the pH may reduce to about 6.4.

A conductivity reading made at the same time gave a reading of 2.3 MS. This is a gross estimate of plant nutrient levels and indicates a high level of available nutrients, but gives no indication of the balance between NPK and trace elements.

The enhanced growth of the wheat seedlings supports the observation that the product would have the ability to support plant growth for an initial but finite period without supplementation.

Trial 6—Sports Field

This was a comparison of sprigs of grass planted directly into the soil of a sports field (the control) and an equal area of field on which planting mats of the unscoured dag wool (as per example 1) were pegged in placed with biodegradable pegs.

Type of Plant: couch grass

Thickness of substrate: 12 mm

Density of substrate: 0.067 g/c.c.

Root depth after 3 months: 350 mm

Control (no substrate) root depth after 3 months: 85 mm

Observations: The grass planted in the natural felt had a far more uniform growth (number of sprigs of grass per square metre) and uniform length than did the grass planted directly in the ground—which had a very uneven and patchy look.

All traces of the woolen felt had disappeared by 4 months after planting.

Types of Wool

Most of the experiments were conducted using sheep wool, especially raw sheep's wool, and dag wool (raw wool containing animal excrements). Whilst it is preferred that the predominant fibre present in the natural felt is raw sheep's wool, other possible wools that could be used include wool waste (waste generated by spinning or weaving mills and finishing operations, although if some of this wool waste is scoured wool, it should only form a very small percentage of the natural felt, as we prefer to use predominately unscoured wool). Much more waste is short fibre wool from sheep, which is rejected prior to scouring as being too short for most textile operations. It is also possible to use pelt wool from the pelts of various mammals including sheep, otter, badgers, goats. More expensive wools such as angora hair, mohair wool, from angora goats or angora rabbits can also be used, although it is likely that the value of those fibres would make it impractical to use them in the natural felts of this invention.

It is also possible to use a small percentage of shoddy (regenerated wool) which is made from wool and fibre obtained from shredding old and new woolen rags. Since woolen rags are made from wool that has been scoured, it is appreciated that only a small percentage of shoddy should be present in the natural felt. In most cases we would prefer that at least 70% of the fibre making up the natural felt is unscoured wool and is preferably unscoured greasy wool from sheep.

Types of Plants

We have tried various forms and thicknesses of the natural felt for a wide variety of plants, including flowers, grasses, herbs, vegetables, ornamental shrubs and trees.

By providing a substrate of uniform thickness and relatively uniform nutrient content (in this case avoiding the use of dried dags) it is believed that the planting mat of this invention is particularly suited to the establishment of large numbers of trees where it is desirable that the seedlings grow at the same rate. By first growing the seedlings in wool it is believed that this gives a better start and a more uniform growth pattern than seedlings planted in soil (where the distribution of trace elements and nitrogen is likely to be highly variable).

We have not as yet experimented with growing rice in the natural felt of this invention but believe it would provide a convenient way of planting rice at uniform spacings directly into the natural felt mats of this invention.

Industrial Application

By mass producing the felted pads or mats in accordance with the previous examples, consisting predominantly of unscoured wool, it is possible to provide a variety of plant substrates whether they are used for hydroponics, or as mats or pads impregnated with seed to allow for the rapid growth of new plants such as instant lawns, herb gardens, or the growth of vegetables.

Advantages of the Preferred Embodiments

It will be appreciated that natural felts of this invention can be used to aid in forestry, horticulture and hydroponics, and provide for the rapid and strong growth of seedlings, as they can derive nutrients from the unscoured wool and from the wool grease (lanolin) and from trace elements contained in the unscoured greasy wool forming the felt pad, and supplemented in some cases by the presence of animal excreta (known by the term “dags”) which have been crushed and distributed throughout the felt pads. They also allow for the use of short fibres that are not useful in other textile applications.

It is believed that by embedding grass seeds in the felt they are less likely to be noticed by or eaten by birds.

The unscoured sheep wool is believed to be worm friendly and microbe friendly. Dense felts can be used to suppress weeds and can also be used to prevent potatoes and other tubes from the light by covering the soil around the potato plants with the natural felt mats.

Variations

Although a number of examples have been described above, it will be appreciated that the invention can be embodied in a number of different forms, and can be diluted with other fibres or other materials preferably organic and biodegradable materials such as waste cellulose, plant fibres, and other animal fibres such as wool, fur, and hair from other species, as well as other waste animal products.

The uses of the natural felt shown in the examples are not to be regarded as limiting the uses of the invention. The natural felt can also be used for transporting other shellfish, fish, fruit and vegetables and plants by moistening the felt with water or salt water to suit the items being transported.

If desired the wool and/or dags can be heat treated to kill any weed seeds present in the wool or dags.

In most cases the felts are produced by needlepunching but any “non-woven” bonding process may be used to hold the fibres together. Some processes use a small percentage of meldable plastics, e.g. polyamide fibres which when heated causes the mass of fibres to bond together.

Composite felts may produced including in part unscoured wool and in part one or more other suitable fibrous products. For example, plant fibres may be added to the felt in a certain proportion. The composite felt may be produced by mixing the additional fibrous product with the unscoured wool prior to carding. Alternatively, webs of different fibres may be superimposed onto each other to form a composite batt that is then needlepunched.

“Natural felt” refers to the fact that it is made up predominately from unscoured animal wool, fur or hair, and preferably mostly unscoured wool from sheep and lambs. “Natural felt” may also include additional plant nutrients, fertilizer, or even weed killers (in some applications) or snail bait or other pesticides.

Various thicknesses of felt can be produced. We have made felts from 2 mm to 60 mm thick. The thickness and extent of needlepunching will depend upon the required application.

If additional plant nutrients were required, this may be achieved by shaking in the required fertiliser or other product. Alternatively, the felt may be drenched into a solution containing the required nutrients and allowed to dry. The pH of the natural felt may be varied by the addition of acidic or basic powders or liquids. Trace elements and growth promoters (such as various seaweed based liquids or plant residue liquors) may be sprayed onto the dried onto the wool during manufacture, and could be added to fibres after carding, or during needlepunching, or even after production of the natural felt.

In most cases it is preferred that these additional nutrients are derived from organic material.

The dags might in some cases be dissolved in water and sprayed into the fibres as a dilute d solution to provide a more uniform distribution of nitrogen throughout the resulting mat than would be the case with inclusion of dry dags.

Where in the foregoing description, reference has been made to specific components or integers of the invention having known equivalents then such equivalents are herein incorporated as if individually set forth.

Although this invention has been described by way of example and with reference to possible embodiments thereof, it is to the understood that modifications or improvements may be made thereto without departing from the scope of the invention.

1. A natural biodegradable felt suitable for growing seeds, seedlings, or plants comprising a mass of predominately unscoured animal wool, hair, or fur.

2. A natural biodegradable felt as claimed in claim 1, suitable for growing seeds, seedlings or plants, or for the transporting fruit, shellfish, fish, vegetables and plants, constructed at least in part from a felt of needlepunched unscoured animal wool.

3. A natural biodegradable felt as claimed in claim 2 wherein, the substrate includes seeds lodged in the felt.

4. A natural biodegradable felt as claimed in claim 2 wherein, the substrate is constructed substantially only from the fibres of unscoured sheep wool and dags.

5. A natural biodegradable felt as claimed in claim 2, having a density from 0.01 to 0.3 g/c.c. and a thickness from 2 mm to 60 mm.

6. A method of manufacturing a natural biodegradable felt suitable for growing seeds, seedlings or plants, the method including producing a batt formed at least in part from unscoured animal wool, needlepunching the batt to form a felt and forming the felt into a required shape or length.

7. A method as claimed in claim 6, wherein the method includes introducing seeds into the felt.

8. A method as claimed in claim 6, wherein the method includes using a portion of dag wool in each batt.

9. A method as claimed in claim 6, wherein the method includes forming a batt using at least 80% of woolen fibres shorter than 20 mm in length.
